(19) United States
(12) Patent Application Publication
(10) Pub. No.: US 2014/0136643 A1
(43) Pub. Date: May 15, 2014

(54) Dynamic Buffer Management for a Multimedia Content Delivery System

(71) Applicant: MOTOROLA MOBILITY LLC, Libertyville, IL (US)

(72) Inventor: Naveen Aerrabotu, Gurnee, IL (US)

(73) Assignee: Motorola Mobility LLC, Libertyville, IL (US)

(21) Appl. No.: 13/675,359

(22) Filed: Nov. 13, 2012

(51) Int. Cl. G06F 15/167

(52) U.S. Cl. CPC G06F 15/167
USPC 709/213

(57) ABSTRACT

A method implemented in a computing device that connects over a network to server computers that host content streams. The method displays content items on the computing device, where each content item includes a link to one of the content streams, determines an amount of available bandwidth on a data connection from the computing device to the network, and associates a pre-fetch buffer and a streaming buffer with each content item. For each content item, the method obtains a measurement based on a condition relative to the linked content stream. The method then calculates, for each content item, a size for the pre-fetch buffer based on the amount of available bandwidth and the measurement, allocates memory for the pre-fetch buffer and the streaming buffer, and initiates a download of a first portion of the linked content stream to the pre-fetch buffer.

### BACKGROUND

Conventional multimedia content delivery systems use streaming media to deliver multimedia content to a computing device operated by a consumer. Streaming media allows the computing device to begin playing the multimedia content before receiving the entire multimedia content file. When the consumer requests a multimedia content file, the computing device initiates a download of the multimedia content file to a buffer for a short time before beginning to play the multimedia content at a carefully controlled rate. The time between the initiation of the download and the start of the playback is a transition time that media player applications need to minimize to improve the consumer's experience.

### BRIEF DESCRIPTION OF THE DRAWINGS

FIG. 1 is a network diagram that illustrates one embodiment of the hardware components of a multimedia content delivery system.

FIG. 2 is a block diagram that illustrates, in detail, one embodiment of the hardware components shown in FIG. 1.

FIG. 3 is a block diagram that illustrates, in detail, one embodiment of the hardware components shown in FIG. 1.

FIG. 4 is a flow diagram that illustrates one embodiment of a method performed by the multimedia content delivery system shown in FIG. 1.

FIG. 5 is a flow diagram that illustrates, in detail, one embodiment of the method shown in FIG. 4.

### DETAILED DESCRIPTION

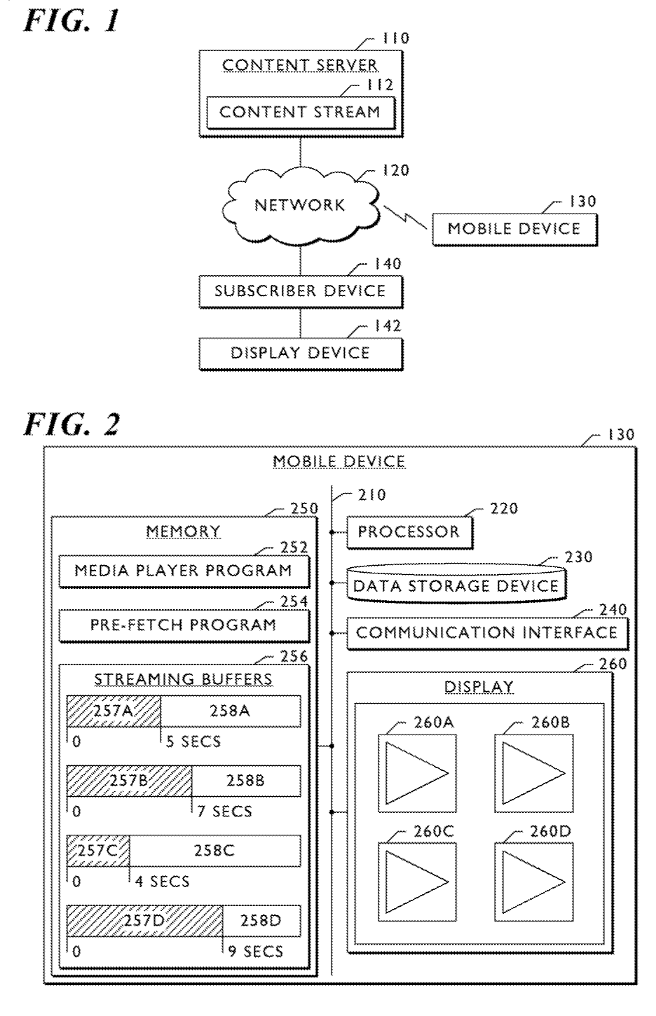

FIG. 1 is a network diagram that illustrates one embodiment of the hardware components of a multimedia content delivery system. The multimedia content delivery system includes a content server 110, network 120, and a client device. In one embodiment, the client device is a mobile device 130 connected via a wireless connection, where the mobile device 130 is a general-purpose computing device such as a mobile phone, smartphone, tablet computer, gaming console, handheld device, or the like. In another embodiment, the client device is a subscriber device 140 connected to a display device 142, where the subscriber device 140 is a general-purpose computing device such as a set top box, personal computer, entertainment device, digital media server, or the like. The content server 110 is a general-purpose server computer that provides access to a content stream 112. The client device (e.g., the mobile device 130, or subscriber device 140) connects to the content server 110 via the network 120 to access and playback the content stream 112 using a media player application. The content stream 112 includes live and recorded streams of digital audio and audio/video multimedia content streams. The multimedia content delivery system shown in FIG. 1 may include any number of interconnected content server 110, network 120, and client device (e.g., the mobile device 130, or subscriber device 140) components.

The network 120 shown in FIG. 1, in one embodiment, is a public Internet Protocol (IP) communication network or wide area network (WAN) that connects the client device (e.g., the mobile device 130, or subscriber device 140) to the content server 110. The multimedia content delivery system shown in FIG. 1 contemplates the use of comparable network architectures including a LAN, a personal area network (PAN) such as a Bluetooth network, a wireless LAN (e.g., a wireless-fidelity (Wi-Fi) network), peer-to-peer overlay network, and a virtual private network (VPN). The multimedia content delivery system shown in FIG. 1 contemplates comparable network architectures and protocols such as Ethernet and transmission control protocol.

FIG. 2 is a block diagram that illustrates, in detail, one embodiment of the hardware components shown in FIG. 1. The mobile device 130 shown in FIG. 2 is a general-purpose computer. A bus 210 is a communication medium connecting a processor 220, data storage device 230, communication interface 240, memory 250, and display 260. Even though the mobile device 130 shown in FIG. 2 includes a single processor 210, one skilled in the art will understand that the mobile device 130 may include a number of processors 210 to improve the speed and efficiency of the mobile device 130. In various embodiments, the data storage device 230 is a serial ATA (SATA) hard disk drive, optical drive, small computer system interface (SCSI) disk, flash memory, or the like. The communication interface 240 connects the mobile device 130 to the network 120, allowing for two-way communication of data and content. In various embodiments, the memory 250 is random access memory (RAM), dynamic RAM (DRAM), non-volatile computer memory, flash memory, or the like.

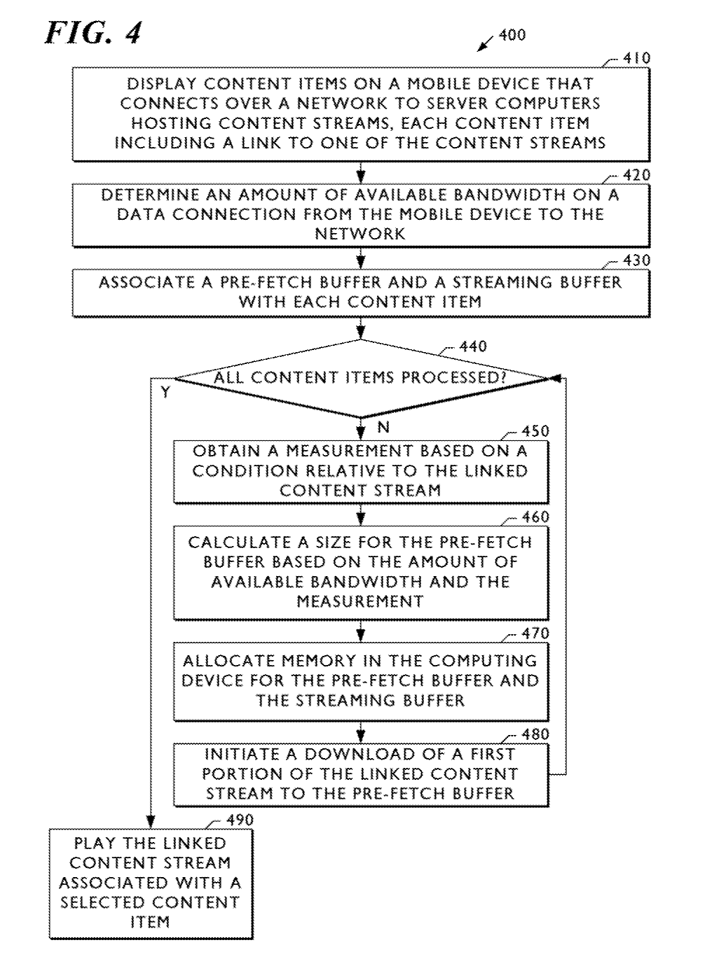

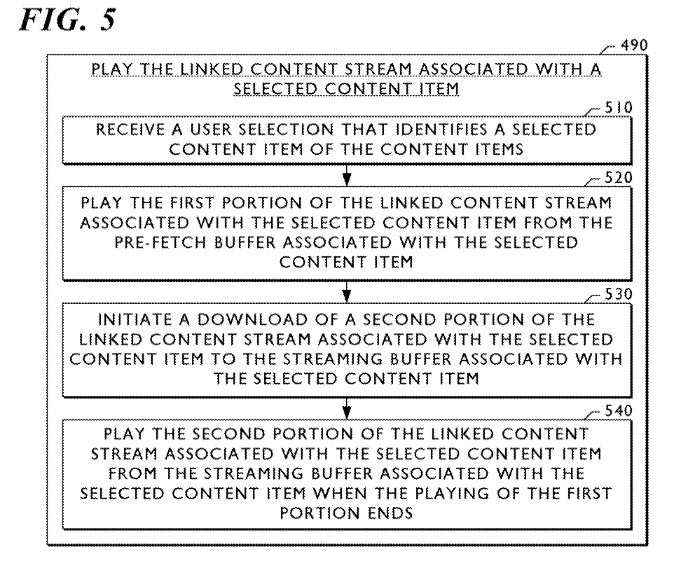

The processor 210 in the mobile device 130 shown in FIG. 2 performs the disclosed methods by executing sequences of operational instructions that comprise each computer program resident in, or operative on, the memory 250. The reader should understand that the memory 250 may include operating system, administrative, and database programs that support the programs disclosed in this application. In one embodiment, the configuration of the memory 250 of the mobile device 130 includes a media player program 252, pre-fetch program 254, and streaming buffers 256. The media player program 252, pre-fetch program 254, and streaming buffers 256 operate to perform the methods disclosed in the exemplary embodiments depicted in FIG. 4 and FIG. 5. When the processor 210 performs the disclosed method, it stores intermediate results in the memory 250 or data storage device 230. In another embodiment, the processor 210 may swap these programs, or portions thereof, in and out of the memory 250 as needed, and thus may include fewer than all of these programs at any one time.

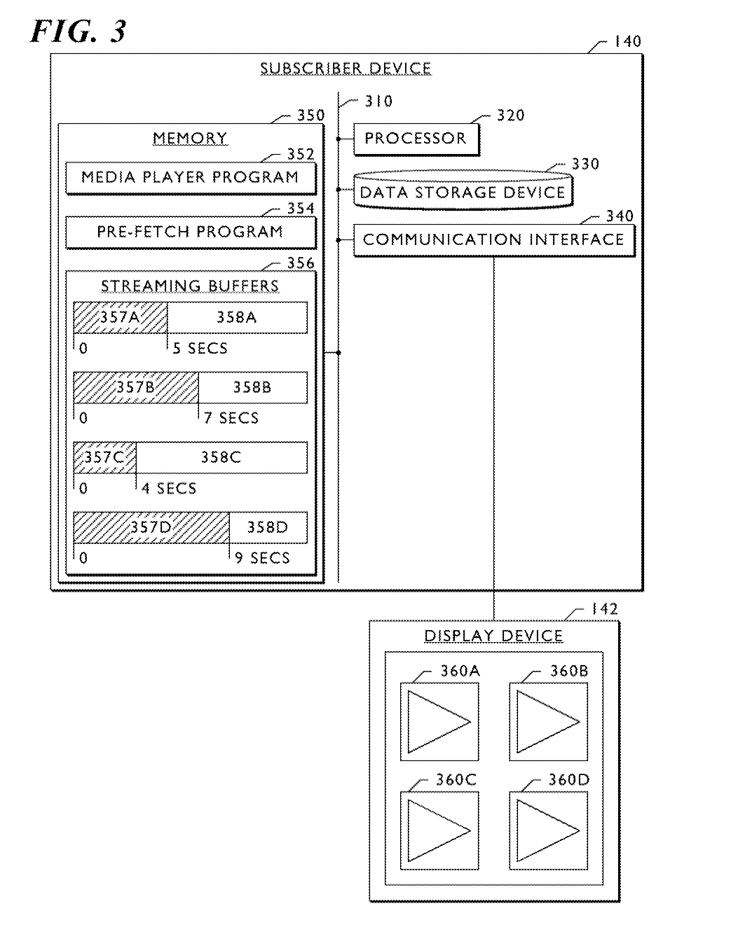

FIG. 3 is a block diagram that illustrates, in detail, one embodiment of the hardware components shown in FIG. 1. The subscriber device 140 shown in FIG. 3, similar to the mobile device 130, is a general-purpose computer. A bus 310 is a communication medium connecting a processor 320, data storage device 330, communication interface 340, and memory 350. Even though the subscriber device 140 shown in FIG. 3 includes a single processor 310, one skilled in the art will understand that the subscriber device 140 may include a number of processors 310 to improve the speed and efficiency of the subscriber device 140. In various embodiments, the data storage device 330 is a serial ATA (SATA) hard disk drive, optical drive, small computer system interface (SCSI) disk, flash memory, or the like. The communication interface 340 connects the subscriber device 140 to the network 120 and a display device 142, allowing for two-way communication of data and content. In various embodiments, the memory 250 is random access memory (RAM), dynamic RAM (DRAM), non-volatile computer memory, flash memory, or the like.

The processor 310 in the subscriber device 140 shown in FIG. 3 performs the disclosed methods by executing sequences of operational instructions that comprise each computer program resident in, or operative on, the memory 350. The reader should understand that the memory 350 may include operating system, administrative, and database programs that support the programs disclosed in this application. In one embodiment, the configuration of the memory 350 of the subscriber device 140 includes a media player program 352, pre-fetch program 354, and streaming buffers 356. The media player program 352, pre-fetch program 354, and streaming buffers 356 operate to perform the methods disclosed in the exemplary embodiments depicted in FIG. 4 and FIG. 5. When the processor 310 performs the disclosed method, it stores intermediate results in the memory 350 or data storage device 330. In another embodiment, the processor 310 may swap these programs, or portions thereof, in and out of the memory 350 as needed, and thus may include fewer than all of these programs at any one time.

FIG. 4 is a flow diagram that illustrates one embodiment of a method performed by the multimedia content delivery system shown in FIG. 1. One skilled in the art will understand that any client device, including the mobile device 130 and subscriber device 140, can perform the process 400 shown in FIG. 4. The process 400, with reference to FIG. 1 and FIG. 2, begins when the media play program 252 displays content items on the display 260 of the mobile device 130 (step 410). The embodiment shown in FIG. 2 illustrates four content items 260A, 260B, 260C, 260D on the display 260. Each content item 260A, 260B, 260C, 260D shown on the display 260 includes a link to a content stream on a content server, such as the content stream 112 on the content server 110 shown in FIG. 1. The pre-fetch program 254 determines an amount of available bandwidth on a data connection from the mobile device 130 to the network 120 (step 420), and associates a pre-fetch buffer 257A, 257B, 257C, 257D and streaming buffer 258A, 258B, 258C, 258D with each content item 260A, 260B, 260C, 260D (step 430).

The process 400 shown in FIG. 4 processes each content item 260A, 260B, 260C, 260D on the display 260 (step 440). For each content item 260A, 260B, 260C, 260D on the display 260 (step 440, N branch), the process 400 obtains a measurement that is based on a condition relative to the linked content stream (step 450). In one embodiment, the condition relative to the linked content stream is a file format for the linked content stream (e.g., MPEG, MPEG-I, MPEG-II, MP3, MP4, WMV, AVI, FLU, MKV, SWF, 3GP, 3G2, 3GPP2, or the like). In another embodiment, the condition relative to the linked content stream is a video resolution of the linked content stream (e.g., 720P, 1080i, 1080P, or the like). In yet another embodiment, the condition relative to the linked content stream is an amount of available bandwidth on a data connection from the network 120 to the content server 110 hosting the content stream 112. The process 400 calculates a size for the pre-fetch buffer 257A, 257B, 257C, 257D for each content item 260A, 260B, 260C, 260D on the display 260 based on the previously-determined amount of available bandwidth on the mobile device and the measurement based on a condition relative to the linked content stream (step 460). Then, for each content item 260A, 260B, 260C, 260D on the display 260, the process 400 allocates memory in the mobile device 130 for the pre-fetch buffer 257A, 257B, 257C, 257D and streaming buffer 258A, 258B, 258C, 258D (step 470), and initiates a download of a first portion of the linked content stream to the pre-fetch buffer 257A, 257B, 257C, 257D (step 480) When all of the content items 260A, 260B, 260C, 260D on the display 260 have been processed (step 440, Y branch), the process 400 is available to play the linked content stream associated with a selected content item (step 490).

The process 400 illustrated in FIG. 4 and FIG. 5 pre-fetches a first portion of the content stream 112 to reduce the time between selection of one of the content items 260A, 260B, 260C, 260D on the display 260 and the start of playback of the content stream 112. The process 400 determines a length (i.e., pre-fetch buffer) of the content stream associated with each content items 260A, 260B, 260C, 260D on the display 260 based on the network conditions for the mobile device 130, and a condition relative to the content stream. Thus, the length of the pre-fetch portion is dynamically determined for each content item 260A, 260B, 260C, 260D on the display 260 because a characteristic of the content stream 122 will be used to determine the length for each content item 260A, 260B, 260C, 260D on the display 260. The dynamic determination of the length of the pre-fetch buffer may differ for each linked content stream. As shown in FIG. 2, the first pre-fetch buffer 257A buffers 5 seconds of the linked content stream, the second pre-fetch buffer 257B buffers 7 seconds of the linked content stream, the third pre-fetch buffer 257C buffers 4 seconds of the linked content stream, and the fourth pre-fetch buffer 257D buffers 9 seconds of the linked content stream.

FIG. 5 is a flow diagram that illustrates, in detail, one embodiment of the method shown in FIG. 4. In particular, FIG. 5 illustrates, in detail, one embodiment of the method shown in FIG. 4 for playing the linked content stream associated with a selected content item (step 490). The media play program 252 receives a user selection that identifies a selected content item of the content items 260A, 260B, 260C, 260D on the display 260 (step 510). In one embodiment, the user selects one of the content items 260A, 260B, 260C, 260D on the display 260 by clicking an icon on a touch screen. The pre-fetch program 254 plays the first portion of the linked content stream associated with the selected content item from the pre-fetch buffer 257A, 257B, 257C, 257D associated with the selected content item (step 520). In one embodiment, the pre-fetch program 254 simultaneously initiates a download of a second portion of the linked content stream associated with the selected content item to the streaming buffer 258A, 258B, 258C, 258D associated with the selected content item (step 530). The pre-fetch program 254 then plays the second portion of the linked content stream associated with the selected content item from the streaming buffer 258A, 258B, 258C, 258D associated with the selected content item when the playing of the first content end (step 540). The playing of the second portion of the linked content stream continues as a conventional solution for streaming a content stream.

Although the disclosed embodiments describe a fully functioning method and computing device for pre-fetching content streams to reduce the time between user selection and the start of playback, the reader should understand that other equivalent embodiments exist. Since numerous modifications and variations will occur to those reviewing this disclosure, the method and computing device for pre-fetching content streams to reduce the time between user selection and the start of playback is not limited to the exact construction and operation illustrated and disclosed. Accordingly, this disclosure intends all suitable modifications and equivalents to fall within the scope of the claims.

We claim:

1. A method implemented in a computing device that connects over a network to at least one server computer hosting at least one content stream, comprising:
displaying at least one content item on the computing device, each content item including a link to one of said at least one content stream;
determining an amount of available bandwidth on a data connection from the computing device to the network;
associating a pre-fetch buffer and a streaming buffer with each content item; and
for each content item,
obtaining a measurement based on a condition relative to the linked content stream;
calculating a size for the pre-fetch buffer based on the amount of available bandwidth and the measurement;
allocating memory in the computing device for the pre-fetch buffer and the streaming buffer; and
initiating a download of a first portion of the linked content stream to the pre-fetch buffer.

2. The method of claim 1, wherein the condition relative to the linked content stream includes at least one of a file format for the linked content stream, a video resolution of the linked content stream, and an amount of available bandwidth on a data connection from the network to the server computer hosting the linked content stream.

3. The method of claim 1, further comprising:
receiving a user selection that identifies a selected content item of said at least one content item;
playing the first portion of the linked content stream associated with the selected content item from the pre-fetch buffer associated with the selected content item;
initiating a download of a second portion of the linked content stream associated with the selected content item to the streaming buffer associated with the selected content item; and
playing the second portion of the linked content stream associated with the selected content item from the streaming buffer associated with the selected content item when the playing of the first portion ends.

4. The method of claim 3, wherein the playing of the first portion, and initiating of the download of the second portion occur simultaneously.

5. The method of claim 3, wherein when the available bandwidth changes before the receiving of the user selection, the method further comprises:
for each content item, reallocating the memory in the computing device for the pre-fetch buffer and the streaming buffer.

6. The method of claim 3, wherein the receiving of the user selection further comprises:
detecting a change to the amount of available bandwidth; and
reallocating the memory in the computing device for the pre-fetch buffer and the streaming buffer associated with the selected content item to account for the change to the amount of available bandwidth.

7. A computing device that connects over a network to at least one server computer hosting at least one content stream, comprising:
a communication interface to connect the computing device to the network;
a memory device resident in the computing device; and
a processor disposed in communication with the communication interface and the memory device, the processor configured to:
display at least one content item on the computing device, each content item including a link to one of said at least one content stream;
determine an amount of available bandwidth on a data connection from the computing device to the network;
associate a pre-fetch buffer and a streaming buffer with each content item; and
for each content item,
obtain a measurement based on a condition relative to the linked content stream;
calculate a size for the pre-fetch buffer based on the amount of available bandwidth and the measurement;
allocate memory in the computing device for the pre-fetch buffer and the streaming buffer; and
initiate a download of a first portion of the linked content stream to the pre-fetch buffer.

8. The computing device of claim 7, wherein the condition relative to the linked content stream includes at least one of a file format for the linked content stream, a video resolution of the linked content stream, and an amount of available bandwidth on a data connection from the network to the server computer hosting the linked content stream.

9. The computing device of claim 7, wherein the processor is further configured to:
receive a user selection that identifies a selected content item of said at least one content item;
play the first portion of the linked content stream associated with the selected content item from the pre-fetch buffer associated with the selected content item;
initiate a download of a second portion of the linked content stream associated with the selected content item to the streaming buffer associated with the selected content item; and
play the second portion of the linked content stream associated with the selected content item from the streaming buffer associated with the selected content item when the playing of the first portion ends.

10. The computing device of claim 9, wherein the processor is further configured to play the first portion, and initiate the download of the second portion simultaneously.

11. The computing device of claim 9, wherein when the available bandwidth changes before the receiving of the user selection, the processor is further configured to:
for each content item, reallocate the memory in the computing device for the pre-fetch buffer and the streaming buffer.

12. The computing device of claim 9, wherein to receive the user selection, the processor is further configured to:
detect a change to the amount of available bandwidth; and
reallocate the memory in the computing device for the pre-fetch buffer and the streaming buffer associated with the selected content item to account for the change to the amount of available bandwidth.

13. A non-transitory computer-readable medium including processor-readable instructions, which when executed by a processor cause the processor to perform operations comprising:
displaying at least one content item on the computing device, each content item including a link to one of said at least one content stream;
determining an amount of available bandwidth on a data connection from the computing device to the network;
associating a pre-fetch buffer and a streaming buffer with each content item; and
for each content item,
obtaining a measurement based on a condition relative to the linked content stream;
calculating a size for the pre-fetch buffer based on the amount of available bandwidth and the measurement;
allocating memory in the computing device for the pre-fetch buffer and the streaming buffer; and
initiating a download of a first portion of the linked content stream to the pre-fetch buffer.

14. The non-transitory computer-readable medium of claim 13, wherein the condition relative to the linked content stream includes at least one of a file format for the linked content stream, a video resolution of the linked content stream, and an amount of available bandwidth on a data connection from the network to the server computer hosting the linked content stream.

15. The non-transitory computer-readable medium of claim 13, further comprising:
receiving a user selection that identifies a selected content item of said at least one content item;
playing the first portion of the linked content stream associated with the selected content item from the pre-fetch buffer associated with the selected content item;
initiating a download of a second portion of the linked content stream associated with the selected content item to the streaming buffer associated with the selected content item; and
playing the second portion of the linked content stream associated with the selected content item from the streaming buffer associated with the selected content item when the playing of the first portion ends.

16. The non-transitory computer-readable medium of claim 15, wherein the playing of the first portion, and initiating of the download of the second portion occur simultaneously.

17. The non-transitory computer-readable medium of claim 15, wherein when the available bandwidth changes before the receiving of the user selection, the method further comprises:
for each content item, reallocating the memory in the computing device for the pre-fetch buffer and the streaming buffer.

18. The non-transitory computer-readable medium of claim 15, wherein the receiving of the user selection further comprises:
detecting a change to the amount of available bandwidth; and
reallocating the memory in the computing device for the pre-fetch buffer and the streaming buffer associated with the selected content item to account for the change to the amount of available bandwidth.
